(19) United States
(12) Patent Application Publication
(10) Pub. No.: US 2016/0327099 A1
(43) Pub. Date: Nov. 10, 2016

(54) ROTATIONAL CONNECTION BY MEANS OF A SELF-LOCKING BEARING

(71) Applicant: SCHAEFFLER TECHNOLOGIES AG & Co. KG, Herzogenaurach (DE)

(72) Inventors: Christian Nuissl, Furth (DE); Christian Schiefhauer, Bad Neustadt a.d. Saale (US); Christian Forstner, Schweinfurt (DE); Harry Girr, Niederwerrn (DE)

(73) Assignee: Schaeffler Technologies AG & Co. KG, Herzogenaurach (DE)

(21) Appl. No.: 15/108,930

(22) PCT Filed: Nov. 27, 2014
(86) PCT No.: PCT/DE2014/200660

§ 371 Date: Jun. 29, 2016

(30) Foreign Application Priority Data
Jan. 16, 2014 (DE) 10 2014 200 725.9

(51) Int. Cl. F16C 41/00; F16C 33/26; F16C 33/10; F16C 33/12; F16C 17/10; F16C 17/24

(52) U.S. Cl. CPC F16C 41/001; F16C 17/10; F16C 17/24; F16C 33/1095; F16C 33/121; F16C 33/26; F16C 2202/54; F16C 2316/10

(57) ABSTRACT

A rotational connection by a self-locking bearing, in particular for supporting a ceiling stand, the bearing including an inner ring and at least one outer ring, in which the bearing is designed as a plain bearing and has an intermediate ring arranged radially between the at least one inner ring and the at least one outer ring. Each ring has at least one annular sliding surface that is inaccessible from outside and a first sliding pair between the at least one inner ring and the outer ring and a second sliding pair between the intermediate ring and the at least one outer ring are provided. A sliding surface of one part of the sliding pair is coated with an anti-friction lacquer.

### FIELD OF THE INVENTION

The invention relates to a rotational connection with a self-locking bearing, in particular, for supporting a ceiling stand, with an inner ring and at least one outer ring.

### BACKGROUND

Rotational connections with a self-locking bearing are needed for different applications. Examples here include ceiling stands, for example, for a medical device, painting robots, bicycle linkages, main bearings of heliostats, and other applications.

In all of the applications, an adjustment or actuation torque that is essentially constant over the service life of the rotational connection and the self-locking bearing is needed. Conventional rotational connections with a self-locking bearing comprise, in most cases, a rolling bearing and a separate braking or friction element, in order to generate the desired self-locking effect. Rotational connections with a self-locking bearing that is based on a rolling bearing can be either low-maintenance connections or connections that require maintenance. In the first case, the connections are greased once. In the second variant, a regular re-lubrication is required. However, if a lubricant such as grease or oil is used in the rolling bearing, there is always the risk of leakage and thus an escape of lubricant out from the interior of the bearing. Thus, applications where cleanliness is a critical factor, for example, a ceiling stand of a medical device mounted in an operating room, are problematic. For use in a clean room, special measures must also be taken to prevent leakage and/or evaporation of the lubricant.

### SUMMARY

The invention is based on the objective of providing a rotational connection with a self-locking bearing that is also suitable for use in areas where cleanliness is a critical factor.

To achieve this objective, in a rotational connection of the type specified above, it is provided according to the invention that the bearing is constructed as a sliding bearing and has an intermediate ring arranged radially between the at least one inner ring and the at least one outer ring, wherein each ring has at least one annular sliding surface that is inaccessible from the outside and wherein a first sliding pair is provided between the at least one inner ring and the outer ring and a second sliding pair is provided between the intermediate ring and the at least one outer ring, wherein a sliding surface of one part of the sliding pair is coated with a sliding lacquer.

Different than for conventional rotational connections with a self-locking bearing, in the rotational connection according to the invention, a rolling bearing is eliminated and instead a sliding surface coated with a sliding lacquer is provided that forms a sliding pair with another sliding surface. This therefore forms a dry-running sliding pair that requires neither grease nor oil, because the two annular sliding surfaces run directly one on the other.

In the rotational connection according to the invention it can be provided that the sliding surface with the sliding lacquer has a base or emergency-run coating on which the sliding lacquer is deposited. This base or emergency-run coating is first deposited during the production and then the sliding lacquer is deposited on the base or emergency-run coating. During normal operation of the rotational connection, the sliding lacquer forms a sliding surface. Only when this sliding lacquer becomes worn does the base or emergency-run coating come into action. The base or emergency-run coating can comprise or consist of, for example, manganese phosphate and/or molybdenum sulfide.

Preferably, all of the mentioned variants have the common feature that the sliding surface of the sliding pair that has no sliding lacquer is, as a rule, uncoated. Preferably, the uncoated sliding surface is a metal surface similar to that of a running surface of a bearing ring.

It is also within the scope of the invention that a sliding pair is constructed as a sliding bearing disk pair, wherein a first sliding bearing disk is arranged on the outer ring and/or a first sliding bearing disk is arranged on the intermediate ring and a second sliding bearing disk is arranged on the at least one outer ring. Accordingly, the rings have corresponding sliding bearing disks that have a bearing-capable surface quality. Two sliding bearing disks each form a sliding pair. One of the sliding bearing disks is coated with the sliding lacquer. The other sliding bearing disk is, in contrast, usually uncoated.

In another construction of the invention it can be provided that the intermediate ring is constructed as adjustment means that can be or is screwed to the inner ring for adjusting the contact pressure and/or the self-locking effect of the sliding bearing. The adjustment can be realized by stronger or weaker screwing of the intermediate ring into the inner ring. Then the adjustment means can be preferably secured by threaded pins, which prevent loosening of the screw connection.

By use of the adjustment means, a desired contact pressure or a contact force of a sliding pair can be generated and/or adjusted. By use of the axial or radial adjustment means, the relative position of the two sliding surfaces of a sliding pair can be at least minimally adjusted, in order to set the desired self-locking effect.

Alternatively or additionally, in the rotational connection according to the invention it can be provided that at least one pre-tensioned spring element is allocated to a sliding pair for generating a specified contact pressure. The at least one spring element presses the two sliding surfaces of the sliding pair against each other with a defined force, so that when the two sliding surfaces rotate relative each other, friction is generated. This friction is desired and generates the self-locking effect, which prevents further rotation of the sliding surfaces and the components connected to these surfaces.

Also conceivable are constructions in which the spring element comprises one or more plate springs or one or more corrugated ring springs that are arranged distributed preferably over the circumference of the sliding surface.

### BRIEF DESCRIPTION OF THE DRAWINGS

An embodiment of the invention is shown in the drawing and is described in more detail below. Shown are:

FIG. 1 a rotational connection according to the invention with a self-locking bearing in a cut side view,

FIG. 2 a top view of the bearing shown in FIG. 1, and

FIG. 3 a perspective view of the bearing shown in FIG. 1.

### DETAILED DESCRIPTION OF THE PREFERRED EMBODIMENTS

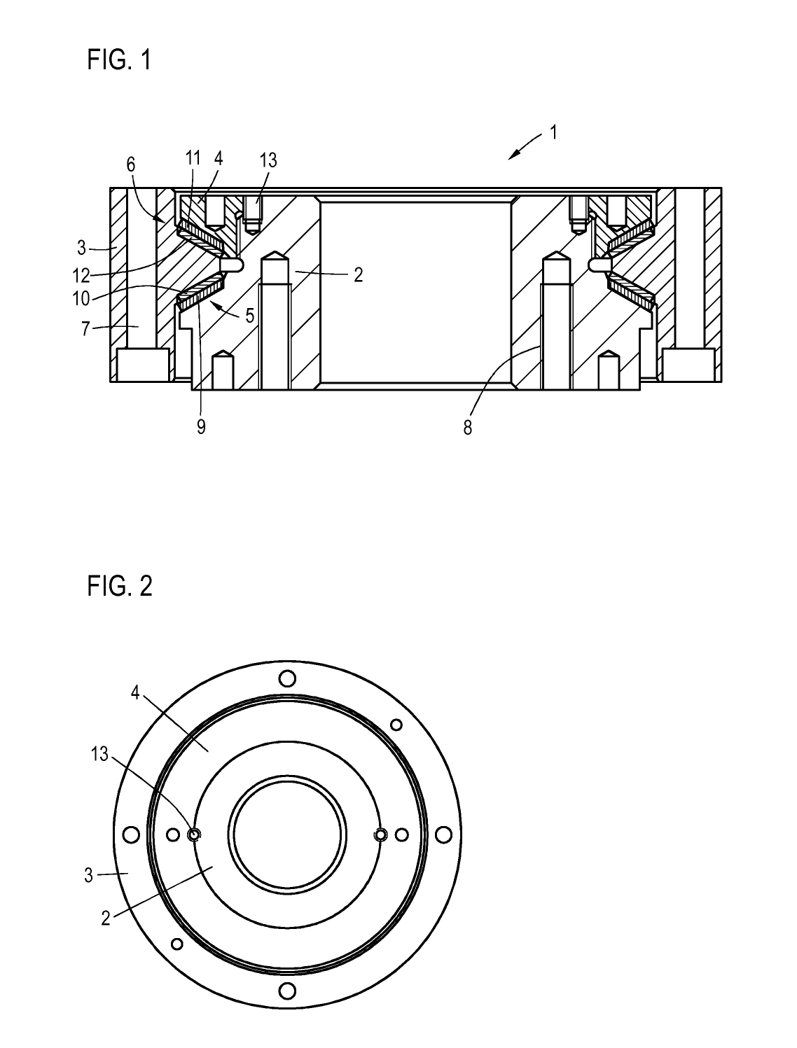

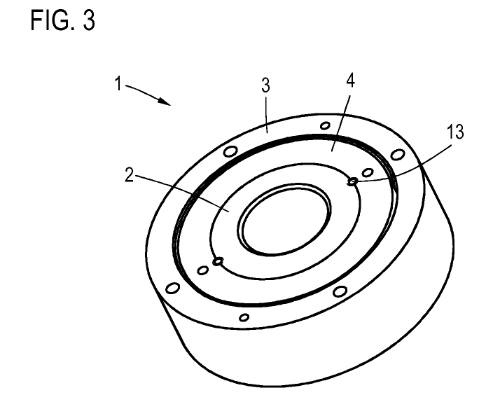

The bearing 1 shown in a cut side view in FIG. 1 is part of a rotational connection with which a ceiling stand of a medical device is supported.

The rotational connection with the self-locking bearing 1 comprises an inner ring 2, an outer ring 3, and an intermediate ring 4 arranged radially between the inner ring 2 and outer ring 3.

A first sliding pair 5 is formed between the inner ring 2 and the outer ring 3; a second sliding pair 6 is formed between the intermediate ring 4 and the outer ring 3. The bearing 1 is thus formed as a sliding bearing. Each sliding pair 5, 6 comprises a sliding surface coated with a sliding lacquer.

The outer ring 3 has a passage hole 7 for connecting the outer ring 3 to another component, for example, a supporting arm of a ceiling stand of a medical device. Similarly, the inner ring 2 has a blind hole thread 8 for connecting the inner ring 2 to another component of the ceiling stand. By use of the bearing 1, two components of a ceiling stand, for example, two supporting arms, are supported so that they can rotate relative to each other.

In the embodiment shown in FIG. 1, it can be seen that the two sliding pairs 5, 6 are constructed as sliding bearing disk pairs. The first sliding pair 5 comprises a first sliding bearing disk 9 on the inner ring 2 and a second sliding bearing disk 10 on the outer ring 3 as well as a first sliding bearing disk 11 on the intermediate ring 4 and a second sliding bearing disk 12 on the outer ring 3.

In the two sliding pairs 5, 6, in each case the first sliding bearing disk 9, 11 has a sliding surface coated with a sliding lacquer. The sliding surface comprises a base or emergency-run coating made from manganese phosphate and/or molybdenum sulfide on which the sliding lacquer is deposited. The sliding surface of the sliding pairs 5, 6 that has no sliding lacquer, thus, the second sliding bearing disks 10, 12 in the shown embodiment, is uncoated.

The intermediate ring 4 shown in FIG. 1 is constructed as an adjustment ring. The axial setting of the contact pressure of the two sliding pairs is realized by a threaded connection of the intermediate ring 4 with the inner ring 2. For this purpose, an external thread is arranged on the outer side of the inner ring 2 and an internal thread is arranged on the inner side of the intermediate ring 4. After the setting of a defined contact pressure, two threaded pins 13 are screwed into corresponding threads of the inner ring 2 that act as an anti-rotating device. The two threads of the inner ring 2 oppose each other; the screwed-in threaded pins 13 prevent loosening of the threaded connection between the inner ring 2 and intermediate ring 4.

In other constructions, a pretensioned spring element, which comprises, in particular, one or more plate springs or one or more corrugated ring springs, can be allocated to a sliding pair for generating a defined contact pressure.

The bearing 1 has the advantage that it is maintenance-free, because the sliding surfaces of the sliding pairs 5, 6 coated with the sliding lacquer require no maintenance by lubrication or oil filling during the entire service life. Because no lubricant is needed, the bearing 1 can also be used in environments in which leakage of the lubricant out of the bearing must absolutely be prevented. Another advantage of the bearing 1 is to be seen in that, due to the elimination of the rolling bodies and a rolling body cage, the installation height is reduced without reducing the load-bearing capacity. The sliding lacquer of the sliding pair consists of a maintenance-free, dry-running sliding lacquer that is deposited on a sliding surface of a sliding bearing disk or angular bearing disk produced without cutting. This sliding bearing disk forms, with another opposing sliding bearing disk, the sliding pair. Alternatively, the sliding bearing disk could also run directly on a mating contour, for example, an outer ring.

The sliding pair 5, 6 provided in the bearing 1 generates a defined actuation and adjustment torque and thus a self-locking force directly in the bearing 1, without additional or separate brake or friction elements being required. In addition, an adaptation or resetting of the self-locking force is possible by the adjustment means.

### LIST OF REFERENCE NUMBERS

1 Bearing

2 Inner ring

3 Outer ring

4 Intermediate ring

5 Sliding pair

6 Sliding pair

7 Passage hole

8 Blind hole thread

9 Sliding bearing disk

10 Sliding bearing disk

11 Sliding bearing disk

12 Sliding bearing disk

13 Threaded pin

1. A rotational connection comprising a self-locking bearing with an inner ring, at least one outer ring, and an intermediate ring arranged radially between the inner ring and the at least one outer ring, wherein each of the rings has at least one annular sliding surface that is inaccessible from outside and a first sliding pair is provided between the inner ring and the at least one outer ring and a second sliding pair is provided between the intermediate ring and the at least one outer ring, and a sliding surface of one part of the first sliding pair and the second sliding pair is coated with a sliding lacquer.

2. The rotational connection according to claim 1, wherein the sliding surface having the sliding lacquer has a base or emergency-run coating on which the sliding lacquer is deposited.

3. The rotational connection according to claim 2, wherein the base or emergency-run coating is made from manganese phosphate or includes manganese phosphate.

4. The rotational connection according to claim 1, wherein a sliding surface of the sliding pair that has no sliding lacquer is uncoated.

5. The rotational connection according to claim 1, wherein one of the sliding pairs is constructed as a sliding bearing disk pair, and a first sliding bearing disk is arranged on the inner ring and a second sliding bearing disk is arranged on the at least one outer ring.

6. The rotational connection according to claim 1, wherein the intermediate ring is constructed as adjustment element that is screwed together with the inner ring for setting at least one of a contact pressure or a self-locking effect of the sliding bearing, and the adjustment element is secured by threaded pins.

7. The rotational connection according to claim 1, wherein at least one pretensioned spring element is allocated to at least one of the sliding pairs for generating a defined contact pressure.

8. The rotational connection according to claim 7, wherein the spring element comprises one or more plate springs or corrugated ring springs.

9. The rotational connection according to claim 1, wherein one of the sliding pairs is constructed as a sliding bearing disk pair, and a first sliding bearing disk is arranged on the intermediate ring and a second sliding bearing disk is arranged on the at least one outer ring.
